(19) United States
(12) Patent Application Publication
(10) Pub. No.: US 2026/0133736 A1
(43) Pub. Date: May 14, 2026

(54) IMAGE FORMING APPARATUS

(71) Applicant: SHARP KABUSHIKI KAIHA, Sakai City (JP)

(72) Inventor: Sungi KIM, Sakai City (JP)

(21) Appl. No.: 19/384,079

(22) Filed: Nov. 10, 2025

(30) Foreign Application Priority Data
Nov. 13, 2024 (JP) 2024-198109

(51) Int. Cl. G06F 3/12; B65H 1/26

(52) U.S. Cl. CPC G06F 3/1279; B65H 1/26; G06F 3/1294; B65H 2511/15; B65H 2511/30; B65H 2601/255; B65H 2801/15

(57) ABSTRACT

An image forming apparatus comprising: an apparatus main body including a sheet discharge tray; and an operation panel, wherein the operation panel includes a touch panel, and a notification lamp that issues a notification, and has a laterally elongated shape in which a length in a left-right direction is larger than a length in an up-down direction in a front view, the operation panel is provided above the sheet discharge tray in a side view, the operation panel is arranged at an apparatus one end portion in a front view, and below the touch panel of the operation panel, of both end portions in the left-right direction, the notification lamp is arranged at an operation panel one end portion proximal to the apparatus one end portion, and a notch portion having a rectangular shape is formed in an operation panel other end portion being the other end.

### CROSS-REFERENCE TO RELATED APPLICATION

The present application claims priority from Japanese Application JP2024-198109, the content to which is hereby incorporated by reference into this application.

### BACKGROUND OF THE INVENTION

### 1. Field of the Invention

The disclosure relates to an image forming apparatus such as a copier, a multifunctional apparatus, a printer, and a facsimile machine apparatus.

### 2. Description of the Related Art

In recent years, there has been provided a compact image forming apparatus whose sizes in a width direction and a depth direction are reduced. Further, in most cases, such an image forming apparatus discharges a sheet to the front (front sheet discharge) in order to reduce the size in the width direction. Moreover, in such an image forming apparatus that adopts front sheet discharge, an operation panel is provided separately from a housing, and is arranged in the vicinity of a sheet take-out port.

Hitherto, an image forming apparatus that adopts front sheet discharge has been known. In the image forming apparatus in the related art, an operation panel is attached at a position above a sheet discharge tray on which a discharged sheet is placed and at a position outside a discharge sheet width.

### SUMMARY

In the image forming apparatus in the related art, the operation panel is arranged so as to protrude to the outside with respect to a right-and-left width of the apparatus main body. Therefore, in the image forming apparatus in the related art, the apparatus as a whole is increased in size as the operation panel protrudes in the width direction of the apparatus main body.

Meanwhile, when an attempt has been made to reduce the size of the apparatus in the width direction and the depth direction and to arrange the operation panel so as to be accommodated within the width direction of the apparatus main body, the operation panel projects to the sheet take-out port. Further, when the operation panel protrudes to the sheet take-out port, a discharged paper collides with the operation panel, which may cause a malfunction such as a sheet crease and a jam. For example, in a case in which the operation panel having a relatively large size (for example, an operation panel of four inches or more) is installed to protrude to the sheet take-out port, and the apparatus is reduced in size in the depth direction, when a sheet having a relatively large size (for example, a legal sheet) is discharged, the leading edge of the sheet protrudes from the sheet take-out port, and collides with the operation panel. As a result, there is a risk that the leading edge of the sheet that collides with the operation panel is creased or that the trailing edge of the sheet is not discharged from a sheet discharge roller and causes a jam (paper jam).

As means for suppressing such a malfunction caused by collision of a sheet with the operation panel (a sheet crease, a jam, and the like), (1) arranging the operation panel above, (2) largely projecting the operation panel, (3) fixing a display surface of the operation panel upward, (4) reducing the number of sheets placed on the sheet discharge tray and reducing a space above the sheet discharge tray, (5) reducing the operation panel in size, and the like may be considered, for example.

However, when an attempt is made to arrange the operation panel at a further upward position as in Item (1) given above, there arise problems in strength of a sheet metal for attaching the operation panel and in the internal structure, which cause difficulties. Further, when the operation panel protrudes further frontward as in Item (2) given above, a dimension including the operation panel in a front-rear direction is increased, and the apparatus as a whole is increased in size. Further, when the operation panel is fixed upward as in Item (3) given above, a user cannot easily visually recognize the operation panel, depending on a height at which the image forming apparatus is installed (for example, on a desk). Further, when the number of sheets placed on the sheet discharge tray is reduced as in Item (4) given above, convenience for a user is degraded.

As described above, the means in Items (1) to (4) cause problems such as an increase in apparatus size, degradation of visibility of the operation panel, and the like. Herein, when the operation panel is reduced in size as in Item (5) given above, a configuration in which the operation panel is prevented from protruding to the sheet take-out port can be achieved. Meanwhile, in recent years, it is desired to increase a size of a display region of a touch panel.

Further, in the image forming apparatus, a lamp (notification lamp) that issues a notification relating to an apparatus state in a predetermined lighting mode, for example, when printing is possible, may be provided. It is desired to provide the notification lamp at a position where the notification is easily visible, thereby enhancing visibility.

In view of this, an object of the disclosure is to provide an image forming apparatus that adopts front sheet discharge and can achieve both an increase in size of a display region of an operation panel and improvement of visibility of a notification lamp while suppressing collision of a sheet with the operation panel at the time of sheet discharge.

In order to solve the above-mentioned problem, an image forming apparatus according to the disclosure includes an apparatus main body including a sheet discharge tray on which a sheet to be discharged forward is placed, and an operation panel. In the image forming apparatus, the operation panel includes a touch panel that receives an operation with respect to the apparatus, and a notification lamp that issues a notification relating to an apparatus state, and has a laterally elongated shape in which a length in a left-right direction is larger than a length in an up-down direction in a front view. The operation panel is provided above the sheet discharge tray so as to protrude frontward from the apparatus main body in a side view. The operation panel is arranged at an apparatus one end portion in a front view, the apparatus one end portion being one of outer left and right ends of the apparatus main body. Below the touch panel of the operation panel, of both end portions in the left-right direction, the notification lamp is arranged at an operation panel one end portion proximal to the apparatus one end portion, and a notch portion having a rectangular shape is formed in an operation panel other end portion being the other end.

According to the image forming apparatus of the disclosure, in an image forming apparatus that adopts front sheet discharge, both an increase in size of a display region of an operation panel and improvement of visibility of a notification lamp can be achieved while suppressing collision of a sheet with the operation panel at the time of sheet discharge.

### BRIEF DESCRIPTION OF THE DRAWINGS

FIG. 1 is a perspective view of an image forming apparatus according to an embodiment of the disclosure.

FIG. 2 is a schematic view illustrating an interior of the image forming apparatus of FIG. 1.

FIG. 3 is a front view of the image forming apparatus of FIG. 1.

FIG. 4 is a side view of the image forming apparatus of FIG. 1.

FIG. 5 is a front view illustrating an operation panel of the image forming apparatus of FIG. 1.

FIG. 6 is a side view illustrating a change of a position of a sheet full detection bar of the image forming apparatus of FIG. 1.

FIG. 7 is a side view illustrating a state in which the sheet full detection bar of the image forming apparatus of FIG. 1 is at a maximum sheet number detection position.

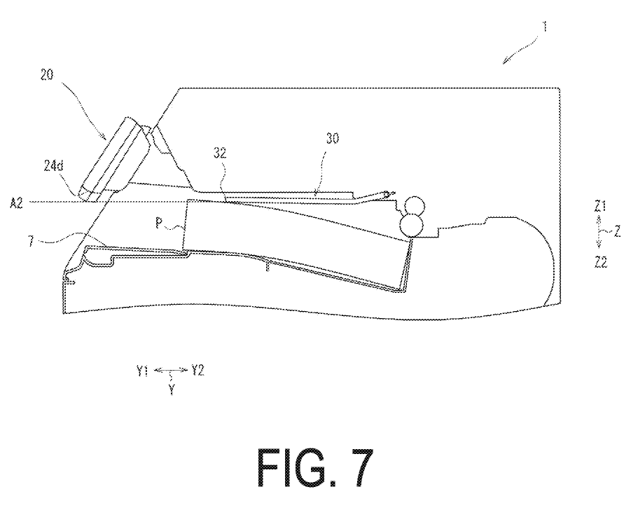

### DETAILED DESCRIPTION OF THE INVENTION

An image forming apparatus 1 according to an embodiment of the disclosure is described below with reference to the drawings. In the following description, the same components are denoted by the same reference numerals. Their names and functions are also the same. Accordingly, detailed descriptions thereof are not repeated.

### Image Forming Apparatus

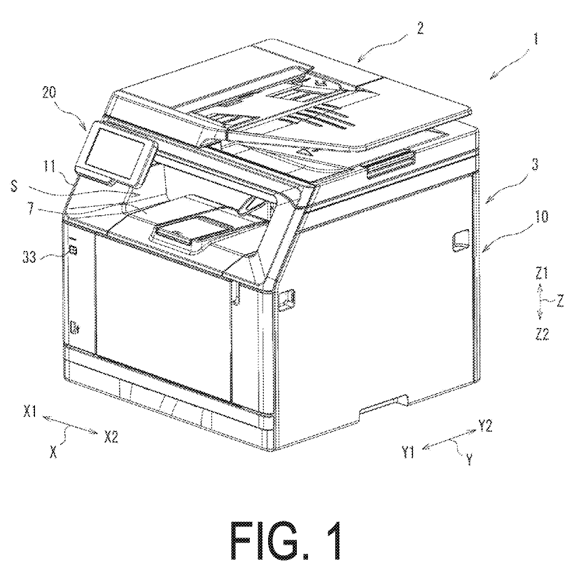

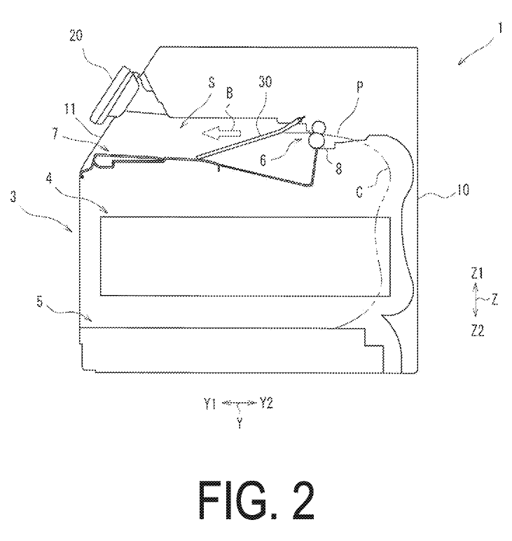

FIG. 1 is a perspective view illustrating the image forming apparatus 1 according to the present embodiment. FIG. 2 is a schematic side view illustrating an interior of the image forming apparatus 1.

The image forming apparatus 1 is a multifunctional apparatus having a copy function, a scanner function, a facsimile machine function, and a printer function. As illustrated in FIG. 1, the image forming apparatus 1 includes a document feeding device 2 and an apparatus main body 3.

In this specification, the left-right direction (the width direction of the image forming apparatus 1) in the state where the image forming apparatus 1 is installed is referred to as a "left-right direction X". In addition, the left side in the left-right direction X is referred to as a "left side X1", and the right side is referred to as a "right side X2". In this specification, the front-rear direction in the state where the image forming apparatus 1 is installed is referred to as a "front-rear direction Y". In addition, the front side in the front-rear direction Y is referred to as a "front side Y1", and the rear side is referred to as a "rear side Y2". In this specification, the up-down direction in the state where the image forming apparatus 1 is installed is referred to as an "up-down direction Z". In addition, the upper side in the up-down direction Z is referred to as an "upper side Z1", and the lower side is referred to as a "lower side Z2".

The image forming apparatus 1 transmits a document image read by an image reader (not illustrated in the drawing) to the outside. In addition, the image forming apparatus 1 forms the document image read by the image reader or an externally received image on a sheet P such as a recording sheet in color or monochrome. The image forming apparatus 1 may be a monochrome image forming apparatus. In addition, the image forming apparatus 1 may be a color image forming apparatus of another type.

As illustrated in FIG. 2, the apparatus main body 3 includes an image former 4, a sheet feed cassette 5, and a housing 10. In addition, although not illustrated in the drawing, the image forming apparatus 1 includes an image reader, an optical scanning device, an intermediate transfer belt device, a secondary transfer device, a fixing device, and the like. The image forming apparatus 1 houses the image former 4, the sheet feed cassette 5, and the like inside the housing 10.

As illustrated in FIG. 2, a sheet conveying path C is formed in the housing 10 of the image forming apparatus 1. The image former 4 forms the image on the sheet P supplied from the sheet feed cassette 5, and the sheet P is conveyed along the sheet conveying path C via the fixing device and the like. The sheet P on which the image is formed is discharged from a discharge port 6 to a sheet discharge tray 7 by a sheet discharge roller 8.

### Embodiments

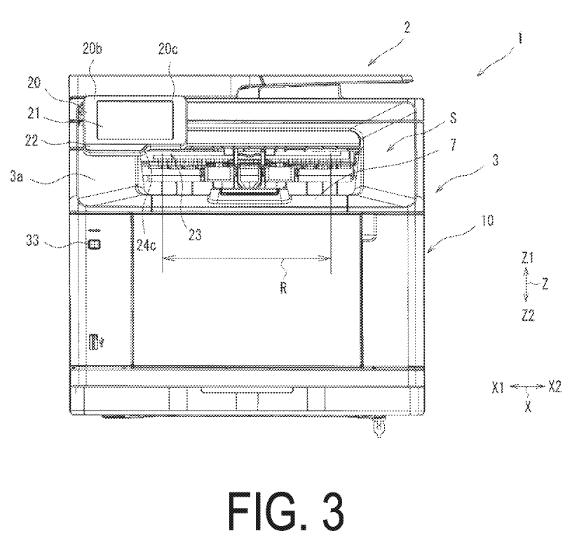

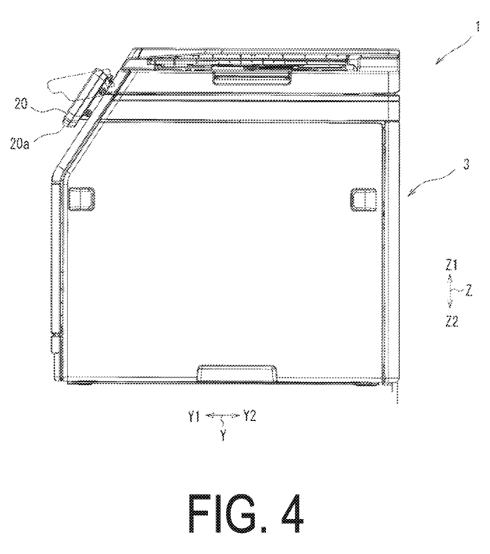

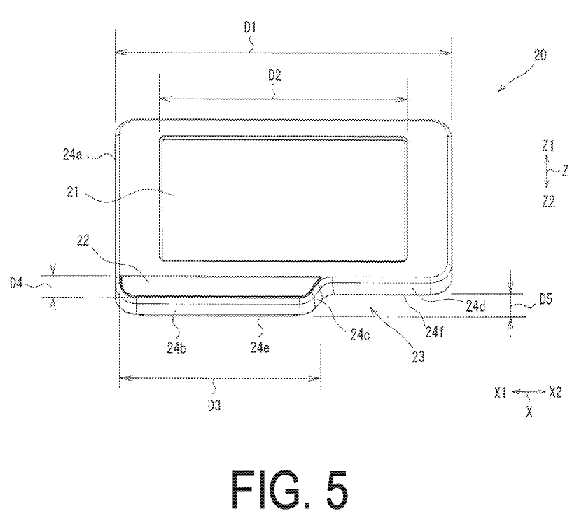

Next, an embodiment of the disclosure is described. FIG. 3 is a front view of the image forming apparatus 1. FIG. 4 is a side view of the image forming apparatus 1. FIG. 5 is a front view of an operation panel 20.

As described above, the image forming apparatus 1 includes the image former 4 and the housing 10. Further, as illustrated in FIG. 2, the image forming apparatus 1 includes the sheet discharge tray 7, the operation panel 20, and a sheet full detection bar 30. Further, as illustrated in FIG. 4, the image forming apparatus 1 includes a power button 33.

As illustrated in FIG. 2, in the image forming apparatus 1, the sheet P is discharged from the discharge port 6 toward the front side Y1. Specifically, the image forming apparatus 1 performs front sheet discharge for discharging the sheet P in the direction from the rear side Y2 to the front side Y1 (a discharge direction B). In addition, as illustrated in FIG. 2, in the housing 10, a sheet discharge space S to which the sheet P is discharged is formed on the front side Y1 of the discharge port 6. As illustrated in FIG. 1, in the housing 10 of the apparatus main body 3, a sheet take-out port 11 serving as an opening for taking out the sheet P is formed on the front side Y1 of the sheet discharge space S.

The discharged sheet P is placed on the sheet discharge tray 7. As illustrated in FIG. 2, the sheet discharge tray 7 is provided on the upper side Z1 of the image former 4. More specifically, as illustrated in FIG. 2, the sheet discharge space S is formed on the upper side Z1 of the image former 4, and the sheet discharge tray 7 is formed on the lower side Z2 of the sheet discharge space S.

The operation panel 20 is a member separated from the apparatus main body 3, and is arranged at the sheet take-out port 11 of the apparatus main body 3. More specifically, as illustrated in FIG. 2, the operation panel 20 is arranged on the upper side of the sheet take-out port 11, and is arranged so as to protrude from the sheet take-out port 11 to the front side Y1.

As illustrated in FIG. 5, the operation panel 20 is provided with a touch panel 21 and a notification lamp 22. The operation panel 20 is a member composed of the touch panel 21 and the notification lamp 22 integrated with each other. As illustrated in FIG. 5, in a front view, the operation panel 20 has a substantially rectangular external appearance with a notch (a notch portion 23) formed therein. A position and a configuration of the notch portion 23 are described later in detail.

The touch panel 21 receives an instruction to the apparatus. In the touch panel 21, which is a liquid crystal display, when various display buttons displayed on the display are touched and selected by the user, the operation is received. The touch panel 21 receives various operations relating to the functions of the image forming apparatus 1, such as printing, fax transmission, and copying.

The notification lamp 22 issues a notification relating to the apparatus state. The notification lamp 22 includes an LED as a light source. The notification lamp 22 issues a notification relating to various apparatus states using combinations of the emission color and the lighting mode (lighting, blinking, and off). Specifically, the notification lamp 22 is a lamp that issues a notification relating to various types of information using the lighting mode such as lighting, blinking, emission color, and the like.

As illustrated in FIG. 5, the notification lamp 22 has a shape whose length in the left-right direction X is greater than the length in the up-down direction Z. Specifically, the notification lamp 22 has a laterally elongated shape. Note that, in the image forming apparatus 1 of the present embodiment, the notification lamp 22 can emit light of two colors (blue light and orange light). For example, the notification lamp 22 emits blue light when a normal operation can be executed, and emits orange light when an error occurs.

As illustrated in FIG. 5, the touch panel 21 has such a size that occupies the majority of the area of the operation panel 20 in a front view. More specifically, the touch panel 21 has a size in the left-right direction X (a touch panel full left-right length D2) that occupies at least one half or more (1/2 or more) and 9/10 or less of the size of the operation panel 20 in the left-right direction X (an operation panel full left-right length D1).

Note that, in the image forming apparatus 1 of the present embodiment, the touch panel 21 has a size of 4 inches. The touch panel full left-right length D2 of the touch panel 21 may be 2/3 or more of the operation panel full left-right length D1. In addition, the touch panel 21 may be 4 inches or more. This can maximize the size of the touch panel 21 while minimizing the size of the operation panel 20.

As illustrated in FIG. 4, in the image forming apparatus 1 of the present embodiment, the operation panel 20 is pivotable with respect to the apparatus main body 3. Specifically, as illustrated in FIG. 4, the operation panel 20 is pivotable so that a lower portion 20a moves to the upper side Z1. In a normal state, the operation panel 20 is in a posture obliquely inclined along the sheet take-out port 11. Further, the operation panel 20 is in a substantially upward-facing horizontal posture while the lower portion 20a moves to the upper side Z1 (see the operation panel 20 indicated by the one-dot chain line in FIG. 4).

In the following description, description is made while the posture of the operation panel 20 is referred to as a “normal position” while the lower portion 20a is on the lower side Z2 and as an “upward-facing position” while the lower portion 20a pivots to move to the upper side Z1 (a substantially upward-facing horizontal state).

When the image forming apparatus 1 is installed on a desk or the like, the operation panel 20 is positioned at the user’s eye level. Thus, in a case in which the image forming apparatus 1 is installed on a desk or the like, when the operation panel 20 is at the normal position, the operation panel 20 is easily visible. In contrast, when the image forming apparatus 1 is installed on a floor surface or the like, the operation panel 20 is positioned on the lower side Z2 with respect to the user’s eye level. Thus, in a case in which the image forming apparatus 1 is installed on a floor surface or the like, when the operation panel 20 is at the upward-facing position, the operation panel 20 is easily visible from the upper side Z1.

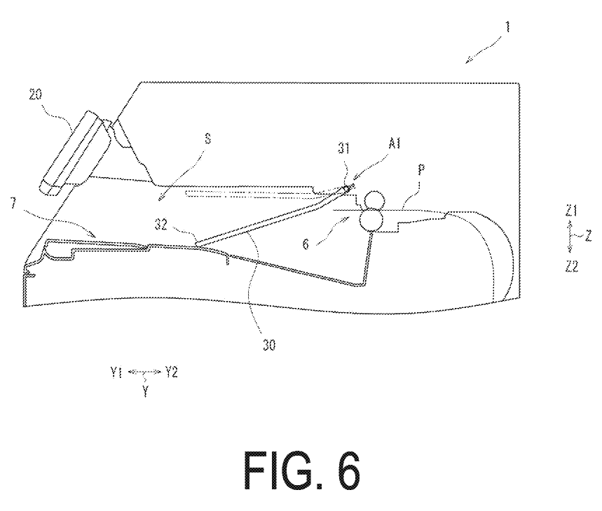

The sheet full detection bar 30 detects that the number of sheets P on the sheet discharge tray 7 reaches a predetermined number. As illustrated in FIG. 6, the sheet full detection bar 30 is arranged in the sheet discharge space S. An end portion (a base end portion 31) of the sheet full detection bar 30 on the rear side Y2 is attached to the apparatus main body 3. Specifically, the sheet full detection bar 30 is attached to the apparatus main body 3 at a position on the front side Y1 of the discharge port 6 and on the upper side Z1 of the sheet discharge tray 7 (an attachment position A1).

As illustrated in FIG. 6, the sheet full detection bar 30 is pivotable with the attachment position A1 as a pivot point. Specifically, an end portion of the sheet full detection bar 30 on the front side Y1 (a distal end portion 32) is a free end, and the distal end portion 32 can be displaced from the lower side Z2 to the upper side Z1.

When the sheet P is not present on the sheet discharge tray 7, the sheet full detection bar 30 is in such a posture that the distal end portion 32 is inclined to the lower side Z2 so that the distal end portion 32 comes into contact with the upper surface of the sheet discharge tray 7. Meanwhile, as the number of sheets P on the sheet discharge tray 7 is increased, the sheet full detection bar 30 is in such a posture that the distal end portion 32 is at the upper side Z1. Moreover, when the sheets P on the sheet discharge tray 7 reach a maximum sheet number in the image forming apparatus 1, and the distal end portion 32 reaches a predetermined height, the sheet full detection bar 30 detects that the sheets P on the sheet discharge tray 7 reach the maximum sheet number.

Note that, in this specification, description is made while the position of the distal end portion 32 at which it is detected that the sheets P on the sheet discharge tray 7 reach the maximum sheet number is referred to as a “maximum sheet number detection position A2”.

The power button 33 receives ON/OFF operations of the power source of the apparatus. The power button 33 of the present embodiment is a rocker switch that switches between ON and OFF by pressing one side of the switch, causing the opposite side to rise. This can enhance the operational feel for the user. Note that the power button 33 is not limited to the rocker switch, and may be selected from among various switches such as slide switches and push switches.

### First Embodiment

The notch portion 23 is described more specifically. As illustrated in FIG. 5, in the operation panel 20, the notch portion 23 being a cut-out part in a rectangular shape is formed. As illustrated in FIG. 5, in front view, the notch portion 23 is formed in the lower right portion of the operation panel 20.

Note that, in this specification, description is made while one of outer end portions of the apparatus main body 3 on the left side X1 and the right side X2 (in the present embodiment, an outer end portion on the left side X1) is referred to as an “apparatus one end portion 3a” (see FIG. 3).

Further, in this specification, description is made while, of both the end portions of the operation panel 20 in the left-right direction X, a portion (in the present embodiment, the left portion of the operation panel 20) that is proximal to the apparatus one end portion 3a (in the present embodiment, the left portion of the apparatus main body 3) is referred to as an operation panel one end portion 20b, and the other portion (in the present embodiment, the right portion of the operation panel 20) is referred to as an operation panel other end portion 20c (see FIG. 3).

In this specification, description is made while, of end surfaces in the left-right direction X that form the thickness of the operation panel 20, an end surface on the left side X1 is referred to as a “side end surface 24a”. Further, description is made while, of end surfaces in the up-down direction Z that form the thickness of the operation panel 20, an end surface at the lowermost position on the lower side Z2 is referred to as a “lower end surface 24b”. Further, in this specification, description is made while, of end surfaces that form the thickness of the operation panel 20 and form the notch portion 23, an end surface in the left-right direction X and an end surface on the lower side Z2 are referred to as a “notch portion first end surface 24c” and a “notch portion second end surface 24d”, respectively.

In the image forming apparatus 1, the maximum sheet size that can be handled is the legal size (215.9 × 355.6 millimeters). Note that, in the following description, description is made while the sheet P having a legal size may be simply referred to as a “legal sheet”. In the image forming apparatus 1, it can be understood that the length of the legal sheet in the longitudinal direction is a maximum allowable length.

As described above, the image forming apparatus 1 of the present embodiment performs frontward discharging for discharging the sheet P to the front side Y1. Further, in the image forming apparatus 1 that performs front sheet discharge, when the legal sheet is discharged to the front side Y1, the leading edge of the legal sheet may reach the front side Y1 beyond the housing 10. In such a case, the operation panel 20 arranged outside the housing 10 may collide with the leading edge of the legal sheet.

The image forming apparatus 1 of the present embodiment includes the apparatus main body 3 including the sheet discharge tray 7 on which the sheet P is discharged toward the front side Y1 and the operation panel 20. In the image forming apparatus 1 of the present embodiment, the operation panel 20 includes the touch panel 21 that receives the operation for the apparatus, and the notification lamp 22 that issues a notification relating to an apparatus state, and has a laterally elongated shape in which the length in the left-right direction X is larger than the length in the up-down direction Z in a front view. In the image forming apparatus 1 of the present embodiment, the operation panel 20 is provided on the upper side Z1 of the sheet discharge tray 7 so as to protrude from the apparatus main body 3 to the front side Y1 in a side view. The operation panel 20 is positioned at the apparatus one end portion 3a being one of the outer end portions of the apparatus main body 3 in the left side X1 and the right side X2 (in the present embodiment, the left portion of the apparatus main body 3). Below the touch panel 21 of the operation panel 20, the notification lamp 22 is arranged at the operation panel one end portion 20b of both the end portions in the left-right direction X that is proximal to the apparatus one end portion 3a (the left portion of in the present embodiment, the operation panel 20), and the notch portion 23 having a rectangular shape is formed in the operation panel other end portion 20c being the other end portion thereof (the left portion of in the present embodiment, the operation panel 20).

In the image forming apparatus 1 of the present embodiment, the operation panel 20 is arranged at the apparatus left portion (the apparatus one end portion 3a) and on the upper side Z1 of the sheet discharge tray 7. With this, the image forming apparatus 1 can improve visibility of the sheet P on the sheet discharge tray 7 and the ease of grasping the sheet P with the right hand.

Further, in the image forming apparatus 1 of the present embodiment, the notification lamp 22 is arranged on the lower side Z2 of the touch panel 21, and the part obtained by cutting off a part of the operation panel 20 (the notch portion 23) is provided. In the image forming apparatus 1 of the present embodiment, the notch portion 23 obtained by cutting off a part of the operation panel 20 is provided so as to avoid the leading edge of the legal sheet when the legal sheet having the maximum allowable length is discharged. With this, in the image forming apparatus 1 of the present embodiment, even when the legal sheet having the maximum allowable length is discharged, it is possible to prevent the leading edge of the sheet P from colliding with the operation panel 20 during sheet discharge, the leading edge of the sheet P from bending, and the trailing edge from failing to exit from the sheet discharge roller 8, which causes a jam.

In this manner, in the image forming apparatus 1 of the present embodiment, the apparatus lateral width is reduced as much as possible, and the touch panel 21 is provided while utilizing the region of the operation panel 20 as much as possible. At the same time, the problems can be avoided, such as bending of the leading edge of the sheet P and a jam that are caused by collision of the discharged sheet P with the operation panel 20. Further, in the image forming apparatus 1, in the operation panel 20 that is highly visible for the user, the notification lamp 22 that issues a notification relating to an apparatus state is provided next to the notch portion 23. Thus, visibility of the notification lamp 22 can be improved while suppressing an increase in size of the operation panel 20. Therefore, according to the image forming apparatus 1 of the present embodiment, in the image forming apparatus 1 that performs front sheet discharge, both an increase in size of the display region (the touch panel 21) of the operation panel 20 and improvement of visibility of the notification lamp 22 can be achieved while preventing the sheet P from colliding with the operation panel 20 during sheet discharge.

In the image forming apparatus 1 of the present embodiment, the notification lamp 22 also issues a notification relating to a printable state when the power is ON and a notification relating to a non-printable state. Further, in the image forming apparatus 1 of the present embodiment, the power button 33 is provided at a position across the sheet discharge tray 7 from the notification lamp 22. Specifically, the power button 33 is arranged at a position close to the notification lamp 22. With this, according to the image forming apparatus 1, the notification lamp 22 easily comes into the field of view when the power button 33 is operated, and visibility of the notification lamp 22 can be improved.

### Second Embodiment

In the image forming apparatus 1 of the present embodiment, the notch portion first end surface 24c being an end surface forming the notch portion 23 in the left-right direction X among the end surfaces forming the operation panel 20 is positioned outside in the left-right direction X with respect to the left and right edges of the sheet P when the sheet P having the maximum size that can be handled by the image forming apparatus 1 is discharged. Herein, “the sheet P having the maximum size that can be handled” indicates that any one of the width, the length, and the area of the sheet P is larger than the sheets P having other sizes that can be handled. Note that, in the image forming apparatus 1 of the present embodiment, all of the width, the length, and the area of the sheet P being the legal sheet are larger than the sheets P having other sizes that can be handled.

As described above, in the image forming apparatus 1, the maximum sheet size that can be handled is the legal size. In the image forming apparatus 1, when the legal sheet (the sheet P) is discharged, the legal sheet is discharged within a range of a sheet discharge region R (see FIG. 3). Further, as illustrated in FIG. 3, in the image forming apparatus 1, the end surface in the left-right direction X that forms the notch portion 23 (the notch portion first end surface 24c) is positioned on the left side X1 (outside) with respect to the sheet discharge region R. Specifically, in the image forming apparatus 1, when the legal sheet is discharged, the notch portion first end surface 24c is positioned on the left side X1 (outside) of the left edge of the legal sheet. In other words, in the image forming apparatus 1, the notch portion first end surface 24c is at a position deviated outward from a position at which the sheet P passes through when the sheet P having the maximum size that can be handled is discharged.

Therefore, according to the image forming apparatus 1 of the present embodiment, even when the sheet P having the maximum size that can be handled (the legal sheet) is discharged, the sheet P can be prevented from colliding with the operation panel 20.

### Third Embodiment

Next, with reference to FIG. 6, the position of the notch portion 23 and the relationship of the sheet full detection bar 30 with respect to the maximum sheet number detection position A2 are described. FIG. 6 is a side view illustrating a state in which the sheet full detection bar 30 is at the maximum sheet number detection position A2.

The image forming apparatus 1 of the present embodiment includes the sheet full detection bar 30 that detects that the sheets P on the sheet discharge tray 7 reach the predetermined maximum sheet number. In the image forming apparatus 1 of the present embodiment, the sheet full detection bar 30 is pivotable with the base end portion 31 as a center. In the image forming apparatus 1 of the present embodiment, the maximum sheet number is detected when the other end portion (the distal end portion 32) pivots upward and reaches the maximum sheet number detection position A2 at the predetermined height. The notch portion second end surface 24d being an end surface forming the notch portion 23 on the lower side Z2 among the end surfaces forming the thickness of the operation panel 20 is positioned on the upper side Z1 with respect to the maximum sheet number detection position A2.

Herein, when the maximum sheet number is detected, discharge of the sheet P is stopped. Therefore, the sheet P is not discharged from a position higher than the distal end portion 32 of the sheet full detection bar 30. In other words, in the image forming apparatus 1, the sheet P is not discharged from a position higher than a maximum height at which the sheet P can be discharged (the maximum sheet number detection position A2). As illustrated in FIG. 6, in the image forming apparatus 1 of the present embodiment, when the operation panel 20 is at the normal position, the position of the notch portion second end surface 24d in the up-down direction Z (the height) is positioned on the upper side Z1 with respect to the maximum sheet number detection position A2. Therefore, according to the image forming apparatus 1 of the present embodiment, when the sheet P is discharged, the sheet P can be prevented from colliding with the operation panel 20.

### Fourth Embodiment

In the image forming apparatus 1 of the present embodiment, the length of the exposed surface of the notification lamp 22 in the up-down direction Z (a notification lamp full up-down length D4) is 2/3 or more of the length of the notch portion 23 in the up-down direction Z (a notch portion full up-down length D5).

The exposed surface of the notification lamp 22 is a portion of the notification lamp 22 exposed from the housing of the operation panel 20. Specifically, the length of the exposed surface of the notification lamp 22 in the up-down direction Z or the left-right direction X indicates the apparent length of the notification lamp 22.

As illustrated in FIG. 5, the length of the notch portion 23 in the up-down direction Z (the notch portion full up-down length D5) indicates a separate distance in the up-down direction Z from a lower end 24e of the lower end surface 24b to a lower end 24f of the notch portion second end surface 24d. In the image forming apparatus 1 of the present embodiment, the notification lamp full up-down length D4 being a full length of the exposed surface of the notification lamp 22 in the up-down direction Z is 2/3 or more of the notch portion full up-down length D5 being a length of the notch portion 23 in the up-down direction Z. More specifically, in the image forming apparatus 1 of the present embodiment, the notification lamp full up-down length D4 has a size equal to the notch portion full up-down length D5.

Specifically, the notification lamp 22 has such a size that occupies the majority in the up-down direction of the portion (the left end portion) other than the notch portion 23 among the lower end portions of the operation panel 20. In other words, in the image forming apparatus 1, the notch (the notch portion 23) is formed in the operation panel 20. At the same time, in the remaining portion (the left lower portion of the operation panel 20), the notification lamp 22 having such a size that occupies the majority of the remaining portion in the up-down direction Z is arranged.

With this, the image forming apparatus 1 of the present embodiment can secure the size of the notification lamp 22 in the up-down direction Z to improve visibility of the notification lamp 22, and can prevent the discharged sheet P from colliding with the operation panel 20.

### Fifth Embodiment

In the image forming apparatus 1 of the present embodiment, the length of the exposed surface of the notification lamp 22 in the left-right direction X (a notification lamp full left-right length D3) is 1/2 or more of the length of the touch panel 21 in the left-right direction X (the touch panel full left-right length D2).

As illustrated in FIG. 5, in the present embodiment, the notification lamp full left-right length D3 of the notification lamp 22 is 1/2 or more and 3/4 or less of the operation panel full left-right length D1. In this manner, the notification lamp 22 provided in the image forming apparatus 1 is of a size that easily catches the user’s eye, unlike a small lamp provided within the operation panel 20.

Thus, according to the image forming apparatus 1 of the present embodiment, the notification lamp 22 easily catches the user’s eye, and the user can notice the notification easily. In this manner, according to the image forming apparatus 1 of the present embodiment, the size of the notification lamp 22 in the left-right direction X can be secured to improve visibility, and the discharged sheet P can be prevented from colliding with the operation panel 20.

### Sixth Embodiment

In the image forming apparatus 1 of the present embodiment, the notification lamp 22 extends in the left-right direction X between the notch portion first end surface 24c being an end surface forming the notch portion 23 in the left-right direction X among the end surfaces forming the thickness of the operation panel 20 and the side end surface 24a being an end surface of the apparatus one end portion among the end surfaces forming the thickness of the operation panel 20.

More details are described. As illustrated in FIG. 5, the notification lamp 22 is arranged between the end surface (the side end surface 24a) of the operation panel 20 on the left side X1 and the end surface (the notch portion first end surface 24c) forming the notch portion 23, and fills the separate distance between those end surfaces. Specifically, the notification lamp 22 has such a size that occupies the majority in the left-right direction of the portion (the left end portion) other than the notch portion 23 among the lower end portions of the operation panel 20. In other words, in the image forming apparatus 1, the notch (the notch portion 23) is formed in the operation panel 20. At the same time, in the remaining portion (the left lower portion of the operation panel 20), the notification lamp 22 having such a size that occupies the majority of the remaining portion in the left-right direction X is arranged.

According to the image forming apparatus 1 of the present embodiment, in the operation panel 20, the notification lamp 22 can occupy the region other than the region where the touch panel 21 is provided, and the size of the notification lamp 22 in the left-right direction X can be secured as much as possible. Therefore, in the image forming apparatus 1 of the present embodiment, visibility of the notification lamp 22 can be improved.

### Seventh Embodiment

In the image forming apparatus 1 of the present embodiment, the operation panel 20 does not include a hardware key.

According to the image forming apparatus 1 of the present embodiment, it is possible to achieve easy operability and size reduction by ensuring the size of the touch panel 21 arranged in the operation panel 20 and achieving a simple configuration while reducing the size of the operation panel 20.

The disclosure is not limited to the embodiments described above and can be implemented in various other forms. Therefore, the embodiments are merely illustrative in all respects and should not be construed in a limiting sense. The scope of the disclosure is indicated by the claims, and is not restricted by the description in the specification. Furthermore, all modifications and alterations falling within the equivalent scope of the claims are included within the scope of the disclosure.

While there have been described what are at present considered to be certain embodiments of the invention, it will be understood that various modifications may be made thereto, and it is intended that the appended claim cover all such modifications as fall within the true spirit and scope of the invention.

What is claimed is:

1. An image forming apparatus comprising:
an apparatus main body including a sheet discharge tray on which a sheet to be discharged forward is placed; and
an operation panel,
wherein the operation panel includes a touch panel that receives an operation with respect to the apparatus, and a notification lamp that issues a notification relating to an apparatus state, and has a laterally elongated shape in which a length in a left-right direction is larger than a length in an up-down direction in a front view,
the operation panel is provided above the sheet discharge tray so as to protrude frontward from the apparatus main body in a side view,
the operation panel is arranged at an apparatus one end portion in a front view, the apparatus one end portion being one of outer left and right ends of the apparatus main body, and
below the touch panel of the operation panel, of both end portions in the left-right direction, the notification lamp is arranged at an operation panel one end portion proximal to the apparatus one end portion, and a notch portion having a rectangular shape is formed in an operation panel other end portion being the other end.

2. The image forming apparatus according to claim 1,
wherein a notch portion first end surface being an end surface forming the notch portion in the left-right direction among end surfaces forming a thickness of the operation panel is positioned outside in the left-right direction with respect to left and right edges of the sheet when the sheet having a maximum size that can be handled by the image forming apparatus is discharged.

3. The image forming apparatus according to claim 1, further comprising:
a sheet full detection bar that detects the sheets on the sheet discharge tray reach a predetermined maximum sheet number,
wherein the sheet full detection bar is pivotable with a base end portion as a center, and detects the maximum sheet number when another end portion pivots upward and reaches a maximum sheet number detection position at a predetermined height, and
a notch portion second end surface being a lower end surface forming the notch portion among end surfaces forming a thickness of the operation panel is positioned above the maximum sheet number detection position.

4. The image forming apparatus according to claim 1,
wherein a length of an exposed surface of the notification lamp in the up-down direction is 2/3 or more of a length of the notch portion in the up-down direction.

5. The image forming apparatus according to claim 1,
wherein a length of an exposed surface of the notification lamp in the left-right direction is 1/2 or more of a length of the touch panel in the left-right direction.

6. The image forming apparatus according to claim 1,
wherein the notification lamp extends in the left-right direction between a notch portion first end surface being an end surface forming the notch portion in the left-right direction among end surfaces forming a thickness of the operation panel and a side end surface being an end surface of the apparatus one end portion among end surfaces forming the thickness of the operation panel.

7. The image forming apparatus according to claim 1,
wherein the operation panel does not include a hardware key.
